(19) United States
(12) Patent Application Publication
(10) Pub. No.: US 2013/0060702 A1
(43) Pub. Date: Mar. 7, 2013

(54) METHODS AND APPARATUS FOR DEMOGRAPHICS INFORMATION COLLECTION

(71) Applicants: Mathew Scott Corson, Gillette, NJ (US); Vincent D. Park, Budd Lake, NJ (US); Michaela Vanderveen, Tracy, CA (US); Zhibin Wu, Bedminster, CA (US); Ranjith S. Jayaram, Cupertino, CA (US); Arthur Stephens, Hazlet, NJ (US); Charles Cullen Childress, Austin, TX (US)

(72) Inventors: Mathew Scott Corson, Gillette, NJ (US); Vincent D. Park, Budd Lake, NJ (US); Michaela Vanderveen, Tracy, CA (US); Zhibin Wu, Bedminster, CA (US); Ranjith S. Jayaram, Cupertino, CA (US); Arthur Stephens, Hazlet, NJ (US); Charles Cullen Childress, Austin, TX (US)

(73) Assignee: QUALCOMM Incorporated, San Diego, CA (US)

(21) Appl. No.: 13/226,721

(22) Filed: Sep. 7, 2011

(51) Int. Cl. G06Q 10/00

(52) U.S. Cl. 705/51; 705/7.33

(57) ABSTRACT

Various embodiments are directed to methods and apparatus which can be used to implement a system for collecting demographic information of users and/or devices in real-time or near real-time. Methods and apparatus directed to communicating and collecting demographic information via wireless signals, e.g., discovery signals, transmitted by one or more wireless devices, e.g., wireless communications devices supporting a peer to peer signaling protocol, are described. In various embodiments, at least some of the demographic information is transmitted in a secure manner.

An information collection device receives demographic information transmitted by wireless communications devices, at least some of said demographic information being transmitted in a secure manner, and forwards collected demographic information to a demographic information processing system. Forwarded demographic information may include decrypted information which has been decrypted by the information collection device and/or received encrypted information which could not be decrypted by the information collection device.

### FIELD

Various embodiments are directed to the collection of demographic information, and more particularly to the collection of real-time or near real-time demographic information from wireless communications devices.

### BACKGROUND

Demographic information is used for a wide variety of applications. One application in which demographic information is used is advertising, where knowledge of the demographics of the target audience is used to make advertisements more relevant

While the demographics associated with a large area may remain relatively constant over time, the demographics of a small area, e.g., the demographics of people within sight of a billboard or store, may change rapidly as people move into the area or leave the area. The usefulness of demographic information often depends on how current the information is and thus how likely it is to be accurate.

While collection of demographic information may be desirable, individuals may not be willing to disclose demographic information to all parties and/or may be willing to disclose demographic information for some uses and not for other uses.

In view of the above discussion, it should be appreciated that there is a need for methods and apparatus which could be used to collect demographic information in or near real time. In addition, it would be desirable if, in some but not necessarily all embodiments, the demographic information could be communicated without publicly disclosing it to all individuals and/or devices in an area.

### SUMMARY

Various embodiments are directed to methods and apparatus which can be used to implement a system for collecting demographic information of users and/or devices in real-time or near real-time. The statistics gathered by the system can be used to modify the behavior of other systems, e.g., advertising systems, that depend on the spatial or temporal distribution of users belonging to demographic groups. For example, a location-based advertising network can target advertisements in a more efficient manner if it knew the demographics of users who are present at locations that are of interest. Another example is determining the advertisement shown on a public billboard e.g., a public display screen in Times Square New York, based on demographic analysis of the people in the neighborhood.

Methods and apparatus related to communicating, collecting, processing and/or forwarding demographic information are described. In various embodiments, demographic information is communicated via wireless signals, e.g., via discovery broadcast signals transmitted by wireless devices using a peer to peer signaling protocol. In some embodiments, at least some of the demographic information is transmitted in a secure manner, e.g., using encryption.

An information collection device collects demographic information announcements that it receives from a plurality of wireless communications devices, e.g., from mobile nodes in its vicinity which are broadcasting demographic information. In some embodiments, some information collection devices are enabled to decrypt all of the encrypted demographic information that they receive. In various embodiments, one or more information collection devices are enabled to decrypt some but not all of the encrypted information that it receives. In some embodiments some information collection devices are restricted to decoding a subset of the communicated demographic information, e.g., a particular information collection device is restricted to decoding a subset of broadcast demographic information used by the particular individual information collection device and/or that the particular information collection device is allowed to access. From the above, it should be appreciated that depending on the embodiment, a system may have device information collection devices with the same or different levels of decryption capability.

In various embodiments, the information collection device may, and sometimes does, forward encrypted and/or decrypted demographic information to a demographic information processing system, e.g., for distribution and/or use. In some embodiments, some information collection devices are not enabled to decrypt received encrypted demographic information, and the encrypted announcements are communicated, e.g., forwarded, to a demographic information processing system for decryption and/or distribution and/or use.

An exemplary method of operating an information collection device, in accordance with some embodiments, comprises: receiving demographic information transmitted by wireless communications devices, at least some of said demographic information being transmitted in a secure manner; and forwarding collected demographic information to a demographic information processing system. An exemplary information collection device in accordance with some embodiments, comprises: at least one processor configured to: receive demographic information transmitted by wireless communications devices, at least some of said demographic information being transmitted in a secure manner; and forward collected demographic information to a demographic information processing system. The exemplary information collection device further comprises memory coupled to said at least one processor.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 is a drawing of an exemplary communications system in accordance with an exemplary embodiment.

FIG. 2 is a flowchart of an exemplary method of operating an information collection device in accordance with an exemplary embodiment.

FIG. 3 is a drawing of an exemplary information collection device in accordance with an exemplary embodiment.

FIG. 4 is an assembly of modules which can, and in some embodiments is, used in the exemplary information collection device illustrated in FIG. 3.

FIG. 5 is a drawing of an exemplary data/information which may be included in an exemplary information collection device of FIG. 3 in accordance with some embodiments.

FIG. 6 is a drawing illustrating an example in which an exemplary information collection device receives encrypted demographic information transmitted by wireless communications devices and forwards collected demographic information to a demographic information processing system in accordance with an exemplary embodiment.

FIG. 7 is a drawing illustrating an example in which exemplary information collection devices receive encrypted demographic information transmitted by wireless communications devices and forwards collected demographic information to a demographic information processing system in accordance with an exemplary embodiment.

FIG. 8 is a drawing of an exemplary peer to peer broadcast signal conveying a demographic announcement in accordance with various exemplary embodiments.

FIG. 9 illustrates an exemplary communications system including a plurality of wireless devices, a plurality of information collection devices, and a demographic information processing system in accordance with an exemplary embodiment.

### DETAILED DESCRIPTION

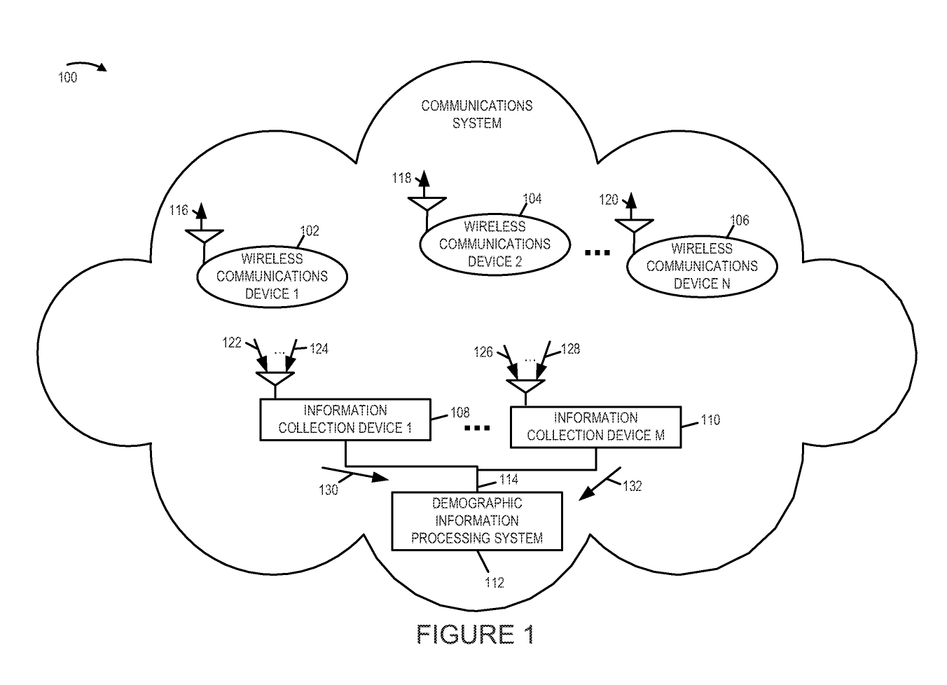

FIG. 1 is a drawing of an exemplary communications system 100 in accordance with an exemplary embodiment. Communications system 100 includes a plurality of wireless communications devices (wireless communications device 1 102, wireless communications device 2 104, . . . , wireless communications device N 106). The wireless communications devices (102, 104, . . . , 106) are, e.g., wireless mobile nodes supporting a peer to peer signaling protocol. Communications system 100 also includes a plurality of information collection devices (information collection device 1 108, . . . , information collection device M 110), and a demographic information processing system 112 coupled together via a backhaul network 114. In some embodiments, some of the information collection devices are mobile devices. In some such embodiments, the demographic information processing system also includes a wireless interface, e.g., for communicating with a mobile information collection device.

The wireless communications devices (102, 104, . . . , 106) transmit, e.g., broadcast, peer to peer signals communicating demographic information (116, 118, . . . , 120), respectively. Information collection devices receive signals communicating demographic information, e.g., broadcast signals communicating demographic information from mobile wireless communications devices which are in its vicinity. Information collection device 1 108 receives signals communicating demographic information (122, . . . , 124). Similarly, information collection device M 110 receives signals communicating demographic information (126, . . . , 128). The information collection devices (108, . . . , 110) perform decryption operations and information forwarding operations on received demographic information. In this example, signal 130 represents forwarded collected demographic information which is being communicated from device 108 to demographic information processing system 112. Some portions of the collected forwarded demographic information may have been decrypted by device 108, while other portions of the forwarded demographic information may be encrypted. Signal 132 represents forwarded collected demographic information which is being communicated from device 110 to demographic information processing system 112.

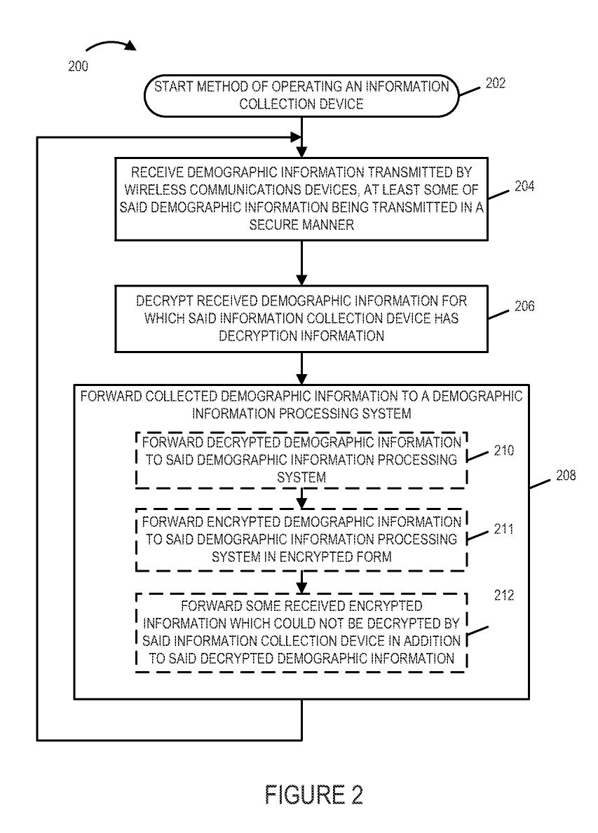

FIG. 2 is a flowchart 200 of an exemplary method of operating an information collection device, e.g., a Demo Point, in accordance with an exemplary embodiment. In some embodiments, a Demo Point receives demographic announcements. Some Demo Points, which correspond to advertising networks, are referred to as AdPoints. The information collection device is, e.g., one of the information collection devices (108, . . . , 110) of communication system 100 of FIG. 1. The exemplary method starts in step 202, where the information collection device is powered on and initialized and proceeds to step 204.

In step 204 the information collection device receives demographic information transmitted by wireless communications devices, at least some of said demographic information being transmitted in a secure manner. In some embodiments, the demographic information transmitted in a secure manner is encrypted using shared encryption. Shared encryption is sometimes referred to as symmetric key encryption. In some embodiments, the demographic information transmitted in a secure manner is encrypted using public key encryption. Public key encryption is sometimes referred to as asymmetric key encryption. In some embodiments, the received demographic information includes encrypted demographic information and information identifying an encryption key used to produce said encrypted demographic information. In some embodiments, the information identifying an encryption key is a key index.

In various embodiments, the received demographic information includes data associated with the device transmitting the information or with the user of the said device. One exemplary set of demographic information includes the user's age, income and gender. Another form of demographic information indicates a group or “tribe” that the user belongs to, e.g., information identifying the user as a music enthusiast, a basketball fan, or an avid hiker. In some embodiments, the received demographic information includes assigned demographic identifiers, each assigned demographic identifier corresponding to previously stored information indicating demographics associated with a device transmitting the received demographic identifier. In some such embodiments, the previously stored information has been previously stored on the demographic information processing system and/or on one or more information collection devices. In some embodiments, the previously stored information is not communicated over a wireless communications link on which said demographic identifier is received. Thus, in some embodiments, in which demographic IDs which map to previously stored sets of demographic information which are not publicly available and which are not normally communicated over the wireless communications link used to transmit the demographic ID, the information collection device uses a non-public look up book to determine the meaning of received demographic IDs. In some such embodiments, the demographic ID may be, and sometimes is, associated with the kinds of demographic information described above, e.g., a user's age, income or gender, or a user's group or tribe. In some embodiments, the demographic IDs are valid for a limited time. In various embodiments, the demographic IDs may, vary over time.

In some embodiments, the received demographic information further includes an identifier, e.g., a Demo Prefix, used to identify the transmitted information as a demographic announcement. In some embodiments, received demographic information includes hashed demographic information. In some such embodiments, the received hashed demographic information is the result of applying a keyed hashing operation on the demographic data associated with the transmitting device or user of the said transmitting device. Operation proceeds from step 204 to step 206.

In some embodiments, the information collection device includes decryption information for use in decrypting a subset of received encrypted information. In step 206 the information collection device decrypts for which said information collection device has decryption information. Operation proceeds from step 206 to step 208. In step 208 the information collection device forwards collected demographic information to a demographic information processing system. Step 208 may, and sometimes does, include one or more of optional steps 210, 211 and 212. In step 210, the information collection device forwards decrypted demographic information to said demographic information processing system. In step 211 the information collection device forwards encrypted demographic information to the demographic information processing system in encrypted form. In step 212, the information collection device forwards some received encrypted information which could not be decrypted by said information collection device in addition to said decrypted demographic information.

Operation proceeds from step 208 to step 204, where the information collection device receives additional demographic information.

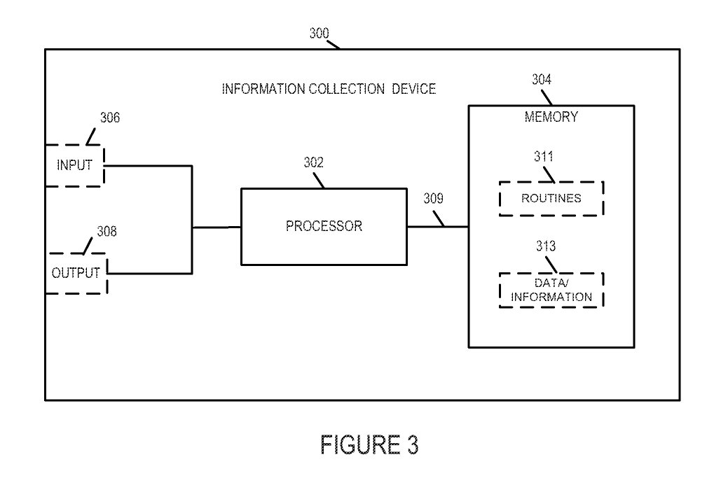

FIG. 3 is a drawing of an exemplary information collection device 300 in accordance with an exemplary embodiment. Exemplary information collection device 300 is, e.g., one of the information collection devices of system 100 of FIG. 1. Exemplary information collection device 300 may, and sometimes does, implement a method in accordance with flowchart 200 of FIG. 2.

Information collection device 300 includes a processor 302 and memory 304 coupled together via a bus 309 over which the various elements (302, 304) may interchange data and information. Information collection device 300 further includes an input module 306 and an output module 308 which may be coupled to processor 302 as shown. However, in some embodiments, the input module 306 and output module 308 are located internal to the processor 302. Input module 306 can receive input signals. Input module 306 can, and in some embodiments does, include a wireless receiver and/or a wired or optical input interface for receiving input. Output module 308 may include, and in some embodiments does include, a wireless transmitter and/or a wired or optical output interface for transmitting output. In some embodiments, memory 304 includes routines 311 and data/information 313.

In some embodiments, processor 302 is configured to: receive demographic information transmitted by wireless communications devices, at least some of said demographic information being transmitted in a secure manner; and forward collected demographic information to a demographic information processing system.

In some embodiments, processor 302 is configured to forward encrypted demographic information to said demographic information processing system in encrypted form, as part of being configured to forward collected demographic information.

In various embodiments, processor 302 is further configured to decrypt received demographic information for which said information collection device has decryption information. In some such embodiments, processor is configured to forward decrypted demographic information to said demographic information processing system as part of being configured to forward collected demographic information.

In some embodiments, memory 304 includes stored decryption information for use in decrypting a subset of received encrypted information; and processor 302 is further configured to forward some received encrypted information which could not be decrypted by said information collection device in addition to said decrypted demographic information, as part of being configured to forward collected demographic information.

In some embodiments, said demographic information transmitted in a secure manner is encrypted using shared key encryption. In some embodiments, said demographic information transmitted in a secure manner is encrypted using public key encryption.

In some embodiments, said received demographic information includes: encrypted demographic information and information identifying an encryption key used to produce said encrypted demographic information.

In some embodiments, said received demographic information includes assigned demographic identifiers, each assigned demographic identifier corresponding to previously stored information indicating demographics associated with a device transmitting the received demographic identifier. In some embodiments, the previously stored information indicating demographics associated with a device transmitting the received demographic identifier has been previously stored on the information collection device. In some embodiments, the previously stored information indicating demographics associated with a device transmitting the received demographic identifier has been previously stored on the demographic information processing system. In some embodiments, said previously stored information is not communicated over a wireless communications link on which said demographic identifier is received.

In some embodiments, said received information further includes an identifier used to identify the transmitted information as a demographic announcement.

In some embodiments, said received demographic information includes hashed demographic information.

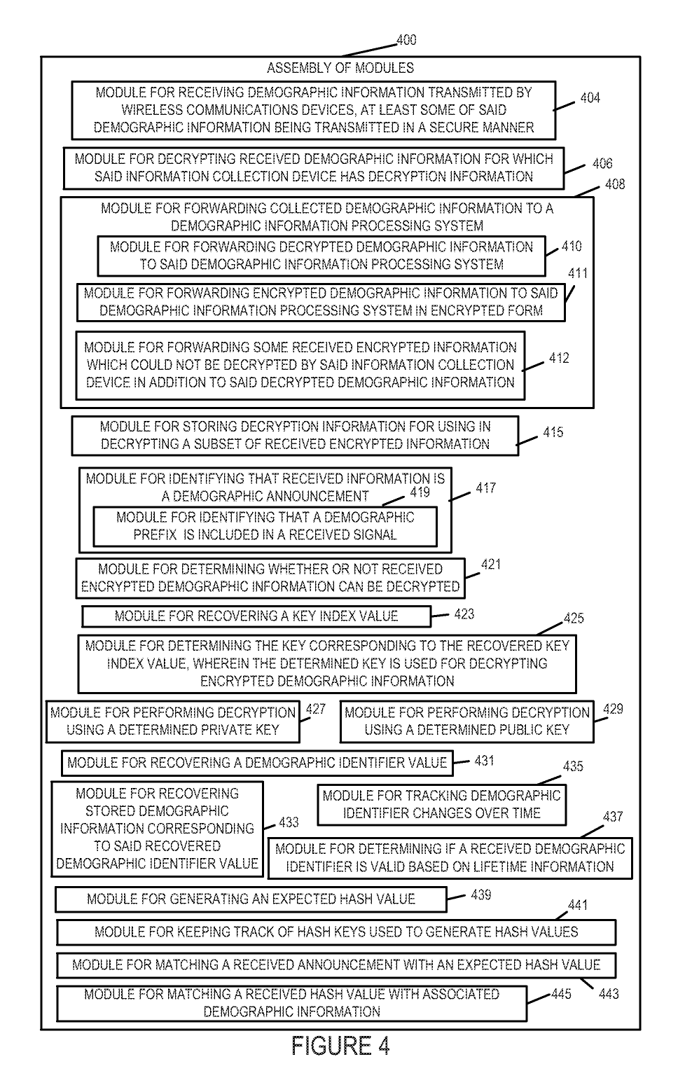

FIG. 4 is an assembly of modules 400 which can, and in some embodiments is, used in the exemplary information collection device 300 illustrated in FIG. 3. The modules in the assembly 400 can be implemented in hardware within the processor 302 of FIG. 3, e.g., as individual circuits. Alternatively, the modules may be implemented in software and stored in the memory 304 of information collection device 300 shown in FIG. 3. In some such embodiments, the assembly of modules 400 is included in routines 311 of memory 304 of device 300 of FIG. 3. While shown in the FIG. 3 embodiment as a single processor, e.g., computer, it should be appreciated that the processor 302 may be implemented as one or more processors, e.g., computers. When implemented in software the modules include code, which when executed by the processor, configure the processor, e.g., computer, 302 to implement the function corresponding to the module. In some embodiments, processor 302 is configured to implement each of the modules of the assembly of modules 400. In embodiments where the assembly of modules 400 is stored in the memory 304, the memory 304 is a computer program product comprising a computer readable medium, e.g., a non-transitory computer readable medium, comprising code, e.g., individual code for each module, for causing at least one computer, e.g., processor 302, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 4 control and/or configure the information collection device 300 or elements therein such as the processor 302, to perform the functions of the corresponding steps illustrated and/or described in the method of flowchart 200 of FIG. 2.

Assembly of modules 400 includes a module 404 for receiving demographic information transmitted by wireless communications devices, wherein at least some of said demographic information is being transmitted in a secure manner, a module 406 for decrypting received demographic information for which said information collection device has decryption information and a module 408 for forwarding collected demographic information to a demographic information process system. Module 408 includes a module 410 for forwarding decrypted demographic information to said demographic information processing system, a module 411 for forwarding encrypted demographic information to said demographic processing system in encrypted form and a module 412 for forwarding some received encrypted information which could not be decrypted by said information collection device in addition to said decrypted demographic information. Assembly of modules 400 further includes a module 415 for storing decryption information for use in decrypting a subset of received encrypted information.

In some embodiment, said demographic information transmitted in a secure manner is encrypted using shared key encryption. In some embodiments, said demographic information transmitted in a secure manner is encrypted using public key encryption. In some embodiments, said received demographic information includes: encrypted demographic information and information identifying an encryption key used to produce said encrypted demographic information.

In some embodiments, said received demographic information includes assigned demographic identifiers, each assigned demographic identifier corresponding to previously stored information indicating demographics associated with a device transmitting the received demographic identifier. In some embodiments, the previously stored information indicating demographics associated with a device transmitting the received demographic identifier has been previously stored on the information collection device. In some embodiments, the previously stored information indicating demographics associated with a device transmitting the received demographic identifier has been previously stored on the demographic information processing system. In some embodiments, said previously stored information is not communicated over a wireless communications link on which said demographic identifier is received.

In some embodiments, said received information further includes an identifier, e.g., a demographic prefix, used to identify the transmitted information as a demographic announcement. In various embodiments, said received demographic information includes hashed demographic information.

Assembly of modules 400 further includes a module 417 for identifying that received information is a demographic announcement. Module 417 includes a module 419 for determining that a demographic prefix is included in a received signal. For example, the detected presence of a demographic prefix, indicates, in some embodiments, that the received signal is a demographic announcement.

Assembly of modules 400 further includes a module 421 for determining whether or not the received encrypted demographic information can be decrypted by the information collection device. For example, the information collection device may or may not have a particular private key that would be used to perform the decryption of the encrypted demographic information.

Assembly of modules 400 further includes a module 423 for recovering a key index value from received demographic information and a module 425 for determining the key corresponding to the recovered key index value, wherein the determined key is used for decrypting encrypted demographic information. Assembly of modules 400 further includes a module 427 for performing decryption using a determined private key and a module 429 for performing decryption using a determined public key.

Assembly of modules 400 further includes a module 431 for recovering a demographic identifier value, a module 433 for recovering stored demographic information corresponding to said recovered demographic identifier value. In some embodiments, an assigned demographic identifier, associated with a particular device, user, group, or module, changes over time, e.g., in accordance with a predetermined hopping pattern. Assembly of modules 400 further includes a module 435 for tracking assigned demographic identifier changes over time. In some embodiments, assigned demographic identifiers are temporary and have associated lifetimes. Assembly of modules 400 further includes a module 437 for determining if a received demographic identifier is valid based on lifetime information.

In some embodiments, the received demographic information includes hashed information. Assembly of modules 400 further includes a module 439 for generating an expected hash value, a module 441 for keeping track of hash keys used to generate has values, a module 443 for matching a received announcement with an expected hash value, and a module 445 for matching a received hash value with associated demographic information.

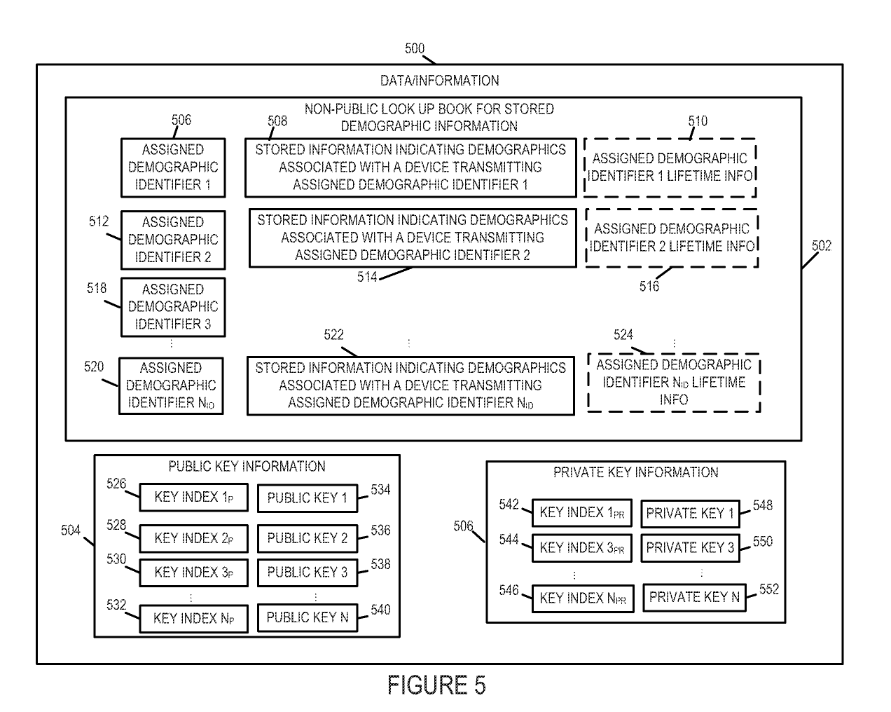

FIG. 5 is a drawing of an exemplary set of data/information 500 which may be included in an exemplary information collection device in accordance with some embodiments. Data/information 500 of FIG. 5 is, e.g., data/information 313 of memory 300 of information collection device 300 of FIG. 3. Data/information 500 includes a non-public look up book for stored demographic information 502, public key information 504, and private key information 506. Non-public look-up book for stored demographic information 502 includes a plurality of assigned demographic identifiers and corresponding stored information indicating demographics associated with a device transmitting the corresponding assigned demographic identifier. In some embodiments, there is a lifetime associated with an assigned demographic identifier and corresponding lifetime information is also included. Look up book 502 includes assigned demographic identifiers (assigned demographic identifier 1 506, assigned demographic identifier 2 512, assigned demographic identifier N_{ID} 520) and corresponding stored information (stored information indicating demographics associated with a service transmitting assigned demographic identifier 1 508, stored information indicating demographics associated with a device transmitting assigned demographic identifier 2 514, stored information indicating demographics associated with a device transmitting assigned demographic identifier N_{ID} 522), respectively, and corresponding lifetime information (assigned demographic identifier 1 lifetime information 510, assigned demographic identifier 2 lifetime information 516, assigned demographic identifier N_{ID} lifetime information 524). In this example, look-up book 502 does not include stored information corresponding to assigned demographic identifier 3 518.

In some embodiments, the assigned demographic identifiers are fixed. In some embodiments, the assigned demographic identifiers are temporary. In some such embodiments, lifetimes are associated with the assigned temporary demographic identifiers. In some embodiments, an assigned demographic identifier varies over time, e.g., in accordance with a time varying function, e.g. a hopping sequence.

In various embodiments, different information collection devices have different non-public look up books for stored demographic information. For example, a first information collection device may have stored information indicating demographics associated with a device transmitting an assigned demographic identifier corresponding to assigned demographic identifiers 1, 2, and N_{ID}; while a second information collection device may have stored information indicating demographics associated with a device transmitting an assigned demographic identifier corresponding to assigned demographic identifiers 1, 3, 4, and N_{ID}. In some embodiments, different information collection devices may have different stored information corresponding to the same assigned demographic identifier. For example, consider that the stored information indicating demographics associated with a device transmitting demographic identifier 1 in a first information collection device may be, and sometime is, different than the stored information indicating demographics associated with the device transmitting demographic identifier 1 in a second information collection device. In one such embodiment, the first and second information devices are associated with different advertisement networks. In another such embodiment, the first and second information collection devices are associated with different stores. In yet another embodiment, the first and second information collection devices are associated with different customer loyalty plans.

Public key information 504 includes a plurality of public key indexes (public key index ip 526, public key index 2p 528, public key index 3p 530, . . . , public key index N_{P} 532) and corresponding stored public keys (public key 1 534, public key 2 536, public key 3 538, . . . , public key N 540). Private key information 506 includes a plurality of private key indexes (private key index 1_{PR} 542, private key index 3_{PR} 544, . . . , private key index N_{PR} 546) and corresponding stored private keys (private key 1 548, private key 3 550, . . . , private key N 552). Different information collection devices may, and sometimes do have different stored private key information. For example, a first information collection device may have stored private keys corresponding to private key indexes 1, 3, and N_{PR}; while a second information collection device may have stored private keys corresponding to private key indexes 1, 2, 4 and N_{PR}.

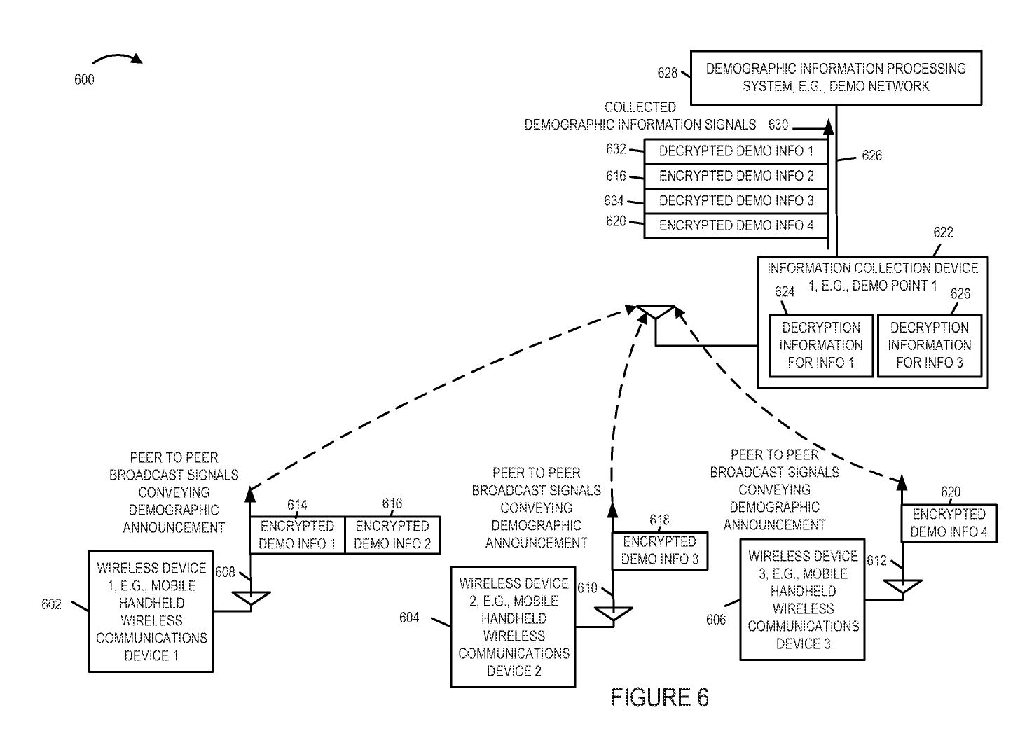

FIG. 6 is a drawing 600 illustrating an example in which an exemplary information collection device, e.g., a demo point, receives encrypted demographic information transmitted by wireless communications devices and forwards collected demographic information to a demographic information processing system in accordance with an exemplary embodiment. Exemplary information collection device 622 of FIG. 6, in some embodiments, implements a method in accordance with flowchart 200 of FIG. 2 and/or is implemented in accordance with information collection device 300 of FIG. 3. Wireless communications device 1 602, e.g., mobile wireless handheld communications device 1, generates and transmits peer to peer broadcast signals 608 conveying a demographic announcement which includes encrypted demographic information 1 614 and encrypted demographic information 2 616. Wireless communications device 2 604, e.g., mobile wireless handheld communications device 2, generates and transmits peer to peer broadcast signals 610 conveying a demographic announcement which includes encrypted demographic information 3 618. Wireless communications device 3 606, e.g., mobile wireless handheld communications device 3, generates and transmits peer to peer broadcast signals 612 conveying a demographic announcement which includes encrypted demographic information 4 620.

The transmitted signals (608, 610, 612) are received by information collection device 1 622, e.g., demo point 1. Information collection device 1 622 includes decryption information 624 for decryption information set 1 and decryption information 626 for decrypting information set 3 626. However, information collection device 1 does not include decryption information for decrypting information set 2 or information set 4. Information collection device 1 622 is coupled to demographic information processing system 628, e.g., a demo network. In some embodiments, a Demo Network aggregates demographic information collected by a plurality of Demo Points. Information collection device 1 622 decrypts received encrypted demographic information 1 614 using stored decryption information for information 1 624 and obtains decrypted demographic information 1 632. Information collection device 1 622 decrypts received encrypted demographic information 3 618 using stored decryption information for information 3 626 and obtains decrypted demographic information 3 634. Information collection device 1 622 generates and transmits collected demographic information signal 630 conveying decrypted demographic information 1 632, encrypted demographic information 2 616, decrypted demographic information 3 634 and encrypted demographic information 4 620 to demographic information processing system 628.

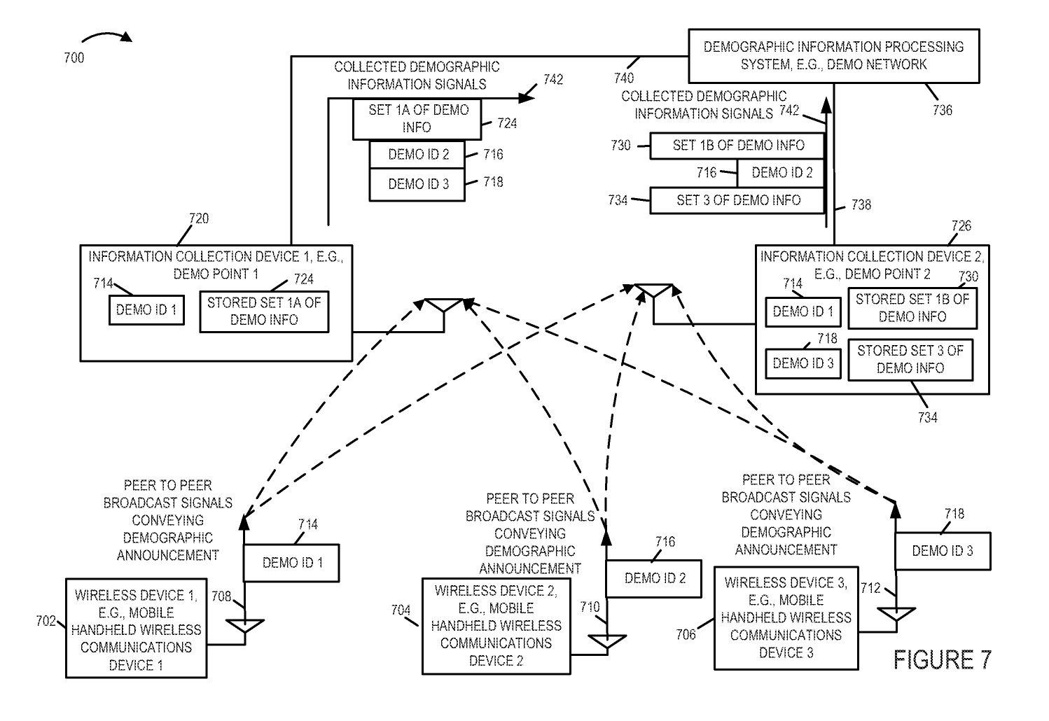

FIG. 7 is a drawing 700 illustrating an example in which exemplary information collection devices, e.g., a demo points, receives encrypted demographic information transmitted by wireless communications devices and forwards collected demographic information to a demographic information processing system in accordance with an exemplary embodiment. Exemplary information collection devices (720, 726) of FIG. 7, in some embodiments, implement a method in accordance with flowchart 200 of FIG. 2 and/or are implemented in accordance with information collection device 300 of FIG. 3. Wireless communications device 1 702, e.g., mobile wireless handheld communications device 1, generates and transmits peer to peer broadcast signals 708 conveying a demographic announcement which includes demographic identifier 1 714. Wireless communications device 2 704, e.g., mobile wireless handheld communications device 2, generates and transmits peer to peer broadcast signals 710 conveying a demographic announcement which includes demographic identifier 2 716. Wireless communications device 3 706, e.g., mobile wireless handheld communications device 3, generates and transmits peer to peer broadcast signals 712 conveying a demographic announcement which includes encrypted demographic identifier 3 718.

The transmitted signals (708, 710, 712) are received by information collection device 1 720, e.g., demo point 1. The transmitted signals (708, 710, 712) are also received by information collection device 2 726, e.g., demo point 2. Information collection device 1 720 includes a non-public look up book mapping demographic identifier 1 714 to stored set 1A of demographic information 724. Information collection device 2 726 includes a non-public look up book mapping: (i) demographic identifier 1 714 to stored set 1B of demographic information 730 and (ii) demographic identifier 3 718 to stored set 3 of demographic information 734.

Information collection device 1 720 processes the received signals (714, 716 and 718), determines that it has stored information corresponding to demo ID 1 714 and retrieves the corresponding stored set 1A of demographic information 724. Information collection device 1 720 is coupled to demographic information processing system 736, e.g., a demo network, via link 740. Information collection device 1 720 generates and transmits signal 742 conveying set 1A of demographic information 724, demographic identifier 2 716 and demographic identifier 3 718 to demographic information processing system 736. Information collection device 2 726 is coupled to demographic information processing system 736, e.g., a demo network, via link 738. Information collection device 2 726 generates and transmits signal 742 conveying set 1B of demographic information 730, demographic identifier 2 716 and set 3 of demographic information 734 to demographic information processing system 736.

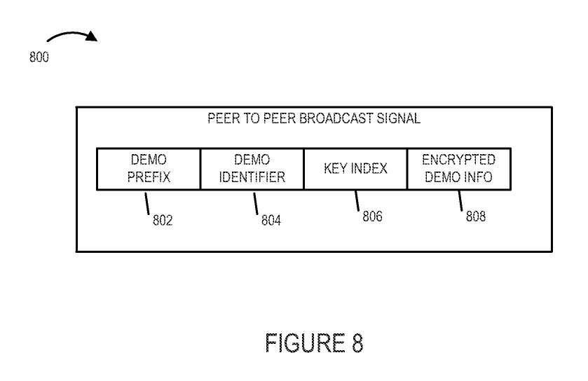

FIG. 8 is a drawing of an exemplary peer to peer broadcast signal conveying a demographic announcement in accordance with various exemplary embodiments. The peer to peer broadcast signal 800, e.g., a peer discovery signal, includes a demo prefix 802, a demographic identifier 804, a key index 806, and encrypted demographic information 808. The demo prefix 802, in some embodiments, identifies that the following information is demographic information, e.g., a demographic announcement. The demographic identifier 804, e.g., an assigned demographic identifier, in some embodiments, corresponds to previously stored information indicating demographics associated with the device transmitting the demographic identifier. In some embodiments, the demographic identifier 804 corresponds to a demographic module in a wireless device. In some embodiments, the demographic identifier 804 corresponds to a wireless device or user of a wireless device or a group in which the user of the wireless device is a member. The key index 806 corresponds to a public or private key that can be used to decrypt the encrypted demographic information 808.

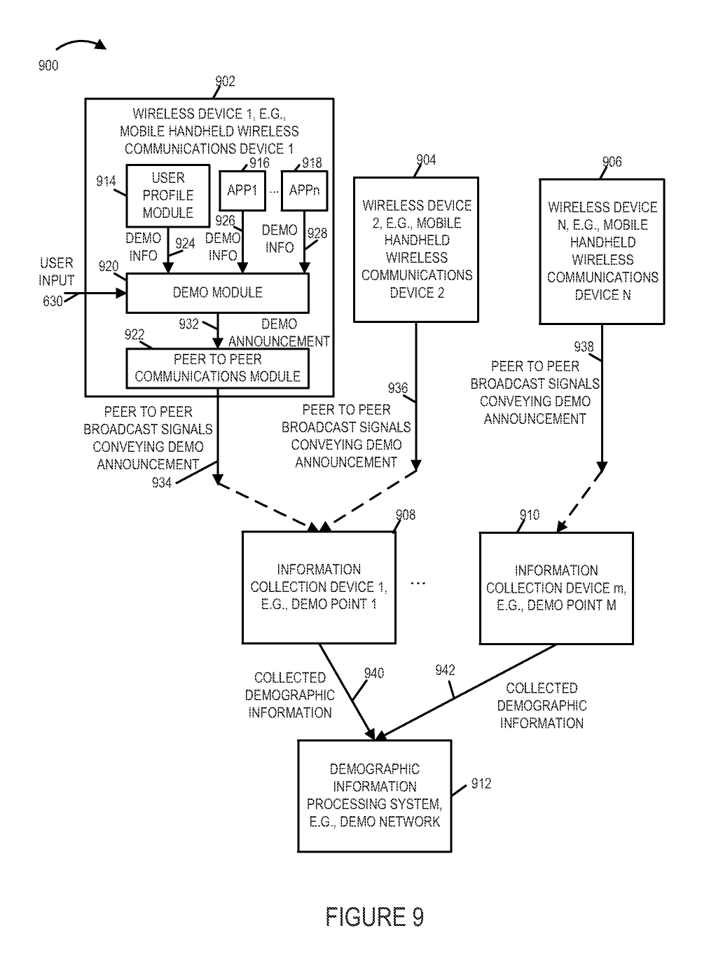

FIG. 9 illustrates an exemplary communications system 900 including a plurality of wireless devices (wireless device 1 902, wireless device 2 904, . . . , wireless device N 906), a plurality of information collection devices (information collection device 1 908, . . . , information collection device m 910), and a demographic information processing system 912. The wireless communications devices (902, 904, . . . , 906) are, e.g., mobile wireless communications devices such as mobile handheld wireless communications devices. The information collection devices (908, . . . , 910), are, e.g., communications devices including a wireless interface. The information collection devices are sometimes referred to as demographic collection points or demo points. In this example, the wireless communications devices (902, 904, 906) and the information collection devices (908, . . . , 910) support a peer to peer wireless signaling protocol. The wireless communications devices (902, 904, . . . , 906) transmit, e.g., broadcast, peer to peer broadcast discovery signals (934, 936, . . . , 938) conveying demographic announcement information corresponding to the devices (902, 904, . . . , 906), respectively, and/or corresponding to the users of the devices (902, 904, . . . , 906), respectively. Depending upon the current location of a wireless communications device, e.g., a mobile, at different times, different information collection devices may be able to receive and recover the peer to peer broadcast signals from the wireless device. As shown in FIG. 9, information collection device 1 908 is receiving and recovering peer to peer broadcast signals (934, 936) conveying demographic information from wireless devices (902, 904), respectively. As shown in FIG. 9, information collection device m 910 is receiving and recovering peer to peer broadcast signal 938 conveying demographic information from wireless device 906. The information collection devices (908, . . . , 910) process the received demographic information and forward collected information (940, . . . , 942) to demographic information processing system 912, e.g., a demographic network. Processing of the received demographic information by an information collection device may, and sometimes does, include decrypting received demographic information for which the information collection device has decryption information. In some embodiments, the information collection device may not be able to decrypt some received encrypted information, and the information decryption device forwards such received encrypted information in encrypted format to the demographic information processing system.

FIG. 9 illustrates wireless devices (902, 904, . . . , 906) generating and transmitting discovery signals (934, 936, . . . , 938) respectively, which may communicate demographic information corresponding to the user of the wireless device and/or the wireless device. The signals (934, 936, . . . , 938) may be received by information collection devices (908, . . . , 910), e.g., Demo Points, which may communicate the received demographic information to demographic information processing system 912, e.g., a DemoNetwork, and/or select advertisements for display based on the received demographic information. In some embodiments, an information collection device, e.g., a Demo Point is an advertising system. The demographic information processing system 912 aggregates information received from the information collection devices (908, . . . , 910).

As shown in FIG. 9, the demographics collection system includes three entities:
1. Wireless devices (902, 904, . . . , 906) that are announcing their user's demographics and/or the devices demographics.
2. Information collection devices (908, . . . , 910), which are sometimes referred to a “DemoPoints”, receive demographic announcements. In some embodiments, an information collection device collecting demographics is an advertising network. In some such embodiments, the DemoPoint is an “AdPoint”. In some embodiments, the information collection device, e.g., Demo Point, also performs processing including decryption operation.
3. A demographic information processing system 912, e.g., a central network, which is sometimes called the “DemoNetwork”, aggregates the demographic information collected by DemoPoints (908, . . . , 910).

On exemplary wireless device 1 902, Demo Module 920 collects demographic information (926, . . . , 928) from other modules on the device such as applications (App 1 916, . . . APP n 918), respectively. Demo Module 920 also collects demographic information 924 from user profile module 914. In addition, Demo Module 920 collects demographic information 930 by directly asking for user input from the user of device 902 and collecting response information. The Demo Module 920 determines the demographics to be announced and generates demo announcement 932. The methods and apparatus described herein may be used for a wide variety of different types of demographic information. A commonly used format is “Age-Income-Gender” information, but the ideas described herein apply also to more general forms of demographic information, e.g., information which might relate a user or device to a group or “tribe”.

Once the DemoModule 920 determines the demo information that it wishes to announce, peer to peer communications module 922 generates and transmits peer to peer broadcast signals 934 conveying the demo announcement 932. In various embodiments, the wireless device 902 announces the info periodically using a broadcast channel. In some embodiments, a peer to peer protocol, e.g., an OFDM based peer to peer signaling protocol, including peer discovery intervals in a recurring peer to peer timing structure and a peer discovery channel, is used. In some such embodiments, peer discovery expressions are used to convey the demo announcement. In some embodiments, a peer discovery expression conveys a relatively small amount of information, e.g., in some embodiments less than 300 bits. In some embodiments, a peer discovery expression conveys less than 200 bits. In one exemplary embodiment a discovery expression conveys 128 bits. In another exemplary embodiment a discovery expression conveys 64 bits. It should be noted that the methods described in the application can be used with a wide variety of broadcast technologies and are not limited to such an exemplary OFDM based embodiment as described above.

To protect the communicated information the demographic info may be, and sometimes is, encrypted for transmission over the air.

A DemoPoint collects demo info announcements it hears. In some embodiments demopoints are enabled to decrypt some or all encrypted demographic information. In other embodiments demopoints are restricted to decoding a subset of the communicated demographic information, e.g., are restricted to decoding a subset used by the particular individual DemoPoint. In still other embodiments, DemoPoints are not enabled to decrypt received encrypted demographic announcements with the encrypted announcements being communicated to the DemoNetwork system for decryption and distribution/use.

If the demo info is encrypted and the DemoPoint has the credentials (keys) used to decrypt the info, it may, and sometimes does, decrypt the info. The DemoPoint then transmits the collected info to the DemoNetwork. For some received demographic information, a Demo Point may not have enough information to decrypt the collected information, e.g., may not have the credential, e.g., keys, used to decrypt the information; however, the Demo Network may have the credentials, e.g., keys, used to decrypt the information. In some embodiments, different DemoPoints may be able to decrypt different received encrypted information. In some embodiments, none of the Demo Points in the system may be able to decrypt a particular set of demographic information being communicated; however, the DemoNetwork may be able to decrypt the information.

Because demographic data is extremely sensitive, it is often transmitted over the air in a private manner, i.e., it is advantageous if transmitted demographic data is not be understandable to third parties which may overhear the demographic communication. It is advantageous that the communicated demographic information can be recovered and understood by the authorized devices, e.g., some DemoPoints and the DemoNetwork, but is not available to other devices or entities, e.g. unauthorized devices. Several methods for securing, e.g., encrypting, communicated demographic information are described below.

A first approach uses public-key encryption. The announcing device, e.g., mobile wireless device 1 902, encrypts its demo announcements with a public key of the Demo Point and/or of the DemoNetwork. In some embodiments, when this approach is used for announcements, the minimum block size for security is 2048 bits for a RSA (Rivest, Shamir and Adleman) encryption embodiment.

A second approach uses IDs associated with the demographic modules in the wireless communications devices transmitting, e.g., broadcasting the demographic information, e.g., uses DemoModule IDs. In some embodiments using this approach, the DemoNetwork keeps persistent state about each of the devices in the system. In some such embodiments, a DemoModule on a device is assigned a unique DemoModuleID, e.g., every DemoModule in the system is assigned a unique DemoModule ID. In some embodiments, a DemoModule updates the DemoNetwork with its demographic information using a secure protocol. The DemoNetwork stores the association between a DemoModuleID and that module's demographics. A DemoModule announces its ID over a peer to peer discovery channel. A direct expression (DEXP), i.e., an expression which directly communicates information without the use of hashing the identification information being communicated, can be, and in some embodiments is, used for this announcement. The structure of the DEXP is: <DemoPrefix>.<DemoModuleID>, where DemoPrefix is a unique prefix that identifies the expression as a demographic announcement. DemoPoints that receive a “Demo-DEXP” forward it to the DemoNetwork, which retrieves the demographics of the announcing device from its database. Alternately, a DemoPoint can query the DemoNetwork to retrieve the demographics for a received Demo-DEXP.

With the above approach, because the DemoModuleID is persistent, a device can be tracked through its over-the-air announcements. In a second variant of this approach, the tracking problem is mitigated by having every DemoModule periodically receive a unique temporary ID from the DemoNetwork. In some embodiments, a temporary ID can be announced over a peer to peer discovery channel as long as its lifetime has not expired. In various embodiments, the lifetime of the temporary ID is also received from the DemoNetwork. In some embodiments, a device can be, and sometimes is, assigned multiple unique temporary IDs. A device with multiple IDs can pick one at random every time it announces its ID.

In a third variant of the approach, devices that belong to the same demographic group may be assigned a “group ID” that they announce over the peer to peer protocol peer discovery channel. In this approach, the IDs are not unique per device and therefore no per-device state needs to be stored on the DemoNetwork, thus reducing tracking and privacy concerns somewhat. As in the case of unique IDs, tracking of IDs over-the-air can be mitigated using temporary group IDs. In some embodiments, another mechanism, e.g., MAC layer, is used in order for the DemoNetwork to distinguish between two different DemoModules broadcasting the same group ID and one DemoModule broadcasting that group ID twice.

In some embodiments using this approach, a Demo Point keeps persistent state about at least some of the devices in the system. In some such embodiments, a DemoModule on a device is assigned a unique DemoModuleID. In some embodiments, a DemoModule updates the Demo Point with its demographic information using a secure protocol. The Demo Point stores the association between a DemoModuleID and that module's demographics. A DemoModule announces its ID over a peer to peer discovery channel. A direct expression (DEXP) can be, and in some embodiments is, used for this announcement. The structure of the DEXP is: <DemoPrefix>.<DemoModuleID>, where DemoPrefix is a unique prefix that identifies the expression as a demographic announcement. DemoPoints that receive a “Demo-DEXP” retrieves the demographics of the announcing device from its memory. Alternately, a DemoPoint can query the DemoNetwork to retrieve the demographics for a received Demo-DEXP.

With the above approach, because the DemoModuleID is persistent, a device can be tracked through its over-the-air announcements. In another variant of this approach, the tracking problem is mitigated by having every Demo Module periodically receive a unique temporary ID, e.g., from a Demo Point or from a Demo Network. In some embodiments, a temporary ID can be announced over a peer to peer discovery channel as long as its lifetime has not expired. In various embodiments, the lifetime of the temporary ID is also received from the Demo Point or from the Demo Network. In some embodiments, a device can be, and sometimes is, assigned multiple unique temporary IDs. A device with multiple IDs can pick one at random every time it announces its ID.

In yet another variant of the approach, devices that belong to the same demographic group may be assigned a “group ID” that they announce over the peer to peer protocol peer discovery channel. In this approach, the IDs are not unique per device and therefore no per-device state needs to be stored on the Demo Point, thus reducing tracking and privacy concerns somewhat. As in the case of unique IDs, tracking of IDs over-the-air can be mitigated using temporary group IDs. In some embodiments, another mechanism, e.g., MAC layer, is used in order for the Demo Point to distinguish between two different Demo Modules broadcasting the same group ID and one Demo Module broadcasting that group ID twice.

In a third approach a pool of symmetric keys is used. In this approach, the DemoNetwork maintains a pool of symmetric keys. Each key is associated with a short key index. Periodically, a DemoModule gets a key and its associated index from the DemoNetwork.

A DemoModule advertises a DEXP on the peer discovery channel. The structure of the DEXP is: <DemoPrefix>.<KeyIndex>.<EncryptedDemoInfo>, where,
DemoPrefix is a unique prefix that identifies the expression as a demographic announcement
KeyIndex (say, 48 bits) is the index of the key assigned to the device, and,
EncryptedDemoInfo (say, 64 bits) is the demographic information of the device encrypted using the key assigned to the device.

A DemoPoint that receives the above DEXP may forward it to the DemoNetwork for decryption. Alternately, a DemoPoint may fetch the key associated with the key index from the DemoNetwork and decrypt a received DEXP locally. In some embodiments, a Demo Point may store a subset of corresponding key index values and corresponding keys for which it is authorized to perform decryption.

In order to mitigate tracking of devices using persistent over-the-air announcements, in some embodiments, the DemoNetwork may refresh its pool of keys periodically and assign new keys to DemoModules periodically. Alternatively or additionally, the EncryptedDemoInfo may also include a time-varying but well-known variable, e.g. MAC-layer timing, that the Demo Point and/or DemoNetwork has knowledge of, as well as the DemoModule itself. In some embodiments, this approach results in a different DEXP being advertised at each opportunity, assuming that the system timing variable is changing more frequently than the DemoModule is scheduled to broadcast its demographic info DEXP.

In a fourth approach hashed expressions are used. In a first variant of this approach, the DemoNetwork maintains a pool of N hashed expressions (HEXPs), i.e. where a hashed expression is a value generated by performing a hash operation on an expression to be communicated and optionally truncating the output of the hash operation. Typically, N is a few hundred. A DemoModule is assigned a HEXP from this pool at random.

A DemoModule advertises its assigned HEXP on the peer discovery channel. In some embodiments, the HEXP includes a direct discriminator (DDISC) portion, and the DDISC portion of the HEXP is set to the demographic information of the device. Because the peer discovery-info of an HEXP is time-varying, tracking of devices using over-the-air announcements is not a problem.

A DemoPoint monitors each of the HEXPs in the system and decodes the DDISC of detected HEXPs. It may then forward the decoded information to the DemoNetwork.

With this approach there is a probability that two devices share the same HEXP. Devices that share HEXPs can decode each others demographic announcements (DDISCs) and thus the privacy of the system is compromised. A related problem is that a few hundred colluding devices can build a list of all HEXPs and thus make sense of all demographic announcements.

To mitigate these problems, a second variant of this approach is more distributed in nature. DemoPoints in an area manage a pool of HEXPs. Either the DemoNetwork can allocate HEXPs to the DemoPoints, or DemoPoints in an area can co-ordinate to determine the HEXP pool.

When a DemoModule wishes to announce demographics, it pages a nearby DemoPoint and gets an HEXP, likely via a secure data-transmission protocol. It also receives metadata containing a list of each of the DemoPoints in the area that monitor the HEXP. DemoModules determine which HEXP to announce based on which DemoPoints are nearby. Typically, a DemoModule would monitor each of the DemoPoints. For instance, a DemoModule would listen for Demo Point identification information, e.g., listen for DemoPoint DEXP prefixes. It could then rank the detected DemoPoints according to some metric. One exemplary metric is, e.g., average received power. The DemoModule then chooses to announce the HEXP associated with the top ranked DemoPoint with the expectation that this DemoPoint is the one that is likeliest to hear and successfully decode the DemoModule's announcements.

Because a pool of HEXPs is limited in geographic scope, the probability of collision is much lower and it becomes much harder for colluding devices to build an exhaustive list of all HEXPs in the system.

In various embodiments a device, e.g., an information collection device (108, . . . , 110) of system 100 of FIG. 1, information collection device 300 of FIG. 3, an information collection device 622 of FIG. 6, an information collection device (720, 726) of FIG. 7 and/or an information collection device (908, . . . , 910) in system 900 of FIG. 9, includes a module corresponding to each of the individual steps and/or operations described with regard to any of the Figures in the present application and/or described in the detailed description of the present application. The modules may, and sometimes are implemented in hardware. In other embodiments, the modules may, and sometimes are, implemented as software modules including processor executable instructions which when executed by the processor of the information collection device cause the device to implement the corresponding step or operation. In still other embodiments, some or all of the modules are implemented as a combination of hardware and software.

The techniques of various embodiments may be implemented using software, hardware and/or a combination of software and hardware. Various embodiments are directed to apparatus, e.g., network nodes, mobile nodes such as mobile terminals, access points such as base stations, and/or communications systems. Various embodiments are also directed to methods, e.g., method of controlling and/or operating network nodes, mobile nodes, access points such as base stations and/or communications systems, e.g., hosts. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In various embodiments nodes described herein are implemented using one or more modules to perform the steps corresponding to one or more methods, for example, signal reception, signal processing, signal generation and/or transmission steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., communications node, including a processor configured to implement one, multiple or all of the steps of one or more methods of the invention.

In some embodiments, the processor or processors, e.g., CPUs, of one or more devices, e.g., communications nodes such as network nodes, access nodes and/or wireless terminals, are configured to perform the steps of the methods described as being performed by the communications nodes. The configuration of the processor may be achieved by using one or more modules, e.g., software modules, to control processor configuration and/or by including hardware in the processor, e.g., hardware modules, to perform the recited steps and/or control processor configuration. Accordingly, some but not all embodiments are directed to a device, e.g., communications node, with a processor which includes a module corresponding to each of the steps of the various described methods performed by the device in which the processor is included. In some but not all embodiments a device, e.g., communications node, includes a module corresponding to each of the steps of the various described methods performed by the device in which the processor is included. The modules may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a communications device or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device or other device described in the present application.

Various embodiments are well suited to communications systems using a peer to peer signaling protocol. Some embodiments use an Orthogonal Frequency Division Multiplexing (OFDM) based wireless peer to peer signaling protocol, e.g., WiFi signaling protocol or another OFDM based protocol.

While described in the context of an OFDM system, at least some of the methods and apparatus of various embodiments are applicable to a wide range of communications systems including many non-OFDM and/or non-cellular systems.

Numerous additional variations on the methods and apparatus of the various embodiments described above will be apparent to those skilled in the art in view of the above description. Such variations are to be considered within the scope. The methods and apparatus may be, and in various embodiments are, used with Code Division Multiple Access (CDMA), OFDM, and/or various other types of communications techniques which may be used to provide wireless communications links between communications devices. In some embodiments one or more communications devices are implemented as access points which establish communications links with mobile nodes using OFDM and/or CDMA and/or may provide connectivity to the internet or another network via a wired or wireless communications link. In various embodiments the mobile nodes are implemented as notebook computers, personal data assistants (PDAs), or other portable devices including receiver/transmitter circuits and logic and/or routines, for implementing the methods.

1. A method of operating an information collection device, the method comprising:
receiving at the information collection device, wireless signals transmitted from wireless communications devices, said wireless signals communicating demographic information, at least some of said demographic information being transmitted in a secure manner as encrypted demographic information;
decrypting, at the information collection device, at least some of said encrypted demographic information; and
forwarding at least some demographic information communicated by said received wireless signals to a demographic information processing system, said at least some demographic information including decrypted demographic information generated by said decrypting.

2. The method of claim 1, wherein said decrypted demographic information generated by said decrypting is generated from encrypted demographic information for which said information collection device has decryption information.

3. The method of claim 1, wherein said received demographic information includes assigned demographic identifiers, each individual assigned demographic identifier corresponding to previously stored information indicating demographics associated with a wireless communications device transmitting the received individual demographic identifier, said wireless communications device being one of said wireless communications devices.

4. The method of claim 3, wherein said previously stored information is not communicated over a wireless communications link on which said demographic identifier is received.

5. The method of claim 2,
wherein forwarding at least some demographic information communicated by said received wireless signals includes forwarding some received encrypted information which could not be decrypted by said information collection device in addition to said decrypted demographic information.

6. The method of claim 1, wherein said received demographic information includes hashed demographic information.

7. An information collection device comprising:
means for receiving at the information collection device, wireless signals transmitted from wireless communications devices, said wireless signals communicating demographic information, at least some of said demographic information being transmitted in a secure manner as encrypted demographic information;
means for decrypting at least some of said encrypted demographic information; and
means for forwarding at least some demographic information communicated by said received wireless signals to a demographic information processing system, said at least some demographic information including decrypted demographic information generated by said means for decrypting.

8. The information collection device of claim 7, wherein said decrypted demographic information generated by said means for decrypting is generated from encrypted demographic information for which said information collection device has decryption information.

9. The information collection device of claim 7, wherein said received demographic information includes assigned demographic identifiers, each individual assigned demographic identifier corresponding to previously stored information indicating demographics associated with a wireless communications device transmitting the received individual demographic identifier, said wireless communications device being one of said wireless communications devices.

10. The information collection device of claim 9, wherein said previously stored information is not communicated over a wireless communications link on which said demographic identifier is received.

11. The information collection device of claim 8, wherein said means for forwarding at least some demographic information communicated by said received wireless signals include means for forwarding some received encrypted information which could not be decrypted by said information collection device in addition to said decrypted demographic information.

12. The information collection device of claim 7, wherein said received demographic information includes hashed demographic information.

13. A computer program product for use in an information collection device, the computer program product comprising:
a non-transitory computer readable medium comprising:
code for causing at least one computer to receive at the information collection device, wireless signals transmitted from wireless communications devices, said wireless signals communicating demographic information, at least some of said demographic information being transmitted in a secure manner as encrypted demographic information;
code for causing said at least one computer to decrypt at least some of said encrypted demographic information; and
code for causing said at least one computer to forward at least some demographic information communicated by said received wireless signals to a demographic information processing system, said at least some demographic information including decrypted demographic information generated by said decrypting.

14. The computer program product of claim 13, wherein said decrypted demographic information is generated from encrypted demographic information for which said information collection device has decryption information.

15. An information collection device comprising:
at least one processor configured to:
receive at the information collection device, wireless signals transmitted from wireless communications devices, said wireless signals communicating demographic information, at least some of said demographic information being transmitted in a secure manner as encrypted demographic information;
decrypt at least some of said encrypted demographic information; and
forward at least some demographic information communicated by said received wireless signals to a demographic information processing system, said at least some demographic information including decrypted demographic information generated by said decrypting; and
memory coupled to said at least one processor.

16. The information collection device of claim 15, wherein said decrypted demographic information generated by said processor by performing decryption is generated from encrypted demographic information for which said information collection device has decryption information.

17. The information collection device of claim 15, wherein said received demographic information includes assigned demographic identifiers, each individual assigned demographic identifier corresponding to previously stored information indicating demographics associated with a wireless communications device transmitting the received individual demographic identifier, said wireless communications device being one of said wireless communications devices.

18. The information collection device of claim 17, wherein said previously stored information is not communicated over a wireless communications link on which said demographic identifier is received.

19. The information collection device of claim 16, wherein said at least one processor is further configured to forward some received encrypted information which could not be decrypted by said information collection device in addition to said decrypted demographic information, as part of being configured to forward at least some demographic information communicated by said received wireless signals.

20. The information collection device of claim 15, wherein said received demographic information includes hashed demographic information.
